(19) United States
(12) Patent Application Publication
(10) Pub. No.: US 2009/0306554 A1
(43) Pub. Date: Dec. 10, 2009

(54) WALKING ASSISTANCE DEVICE

(75) Inventor: Shigenori YASUIE, Wako (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd.

(21) Appl. No.: 12/477,427

(22) Filed: Jun. 3, 2009

(30) Foreign Application Priority Data
Jun. 10, 2008 (JP) 2008-151595

(51) Int. Cl. A61H 3/00

(52) U.S. Cl. 601/5

(57) ABSTRACT

In a walking assistance device, comprising: a hip belt (2) configured to be worn on a waist or hip of a user; a power generator (3) having a base member (33) attached to a side of the hip belt and an output member (21) having an engagement assembly; and a torque transmitting member (4) having an upper end (4A) configured to be retained by the engagement assembly of the output member and a lower end (4B) configured to support a femur of the user; the engagement assembly comprises a latch mechanism for detachably engaging the upper end of the torque transmitting member. By thus allowing the torque transmitting member to be readily and easily attached and detached to and from the hip belt, wearing and removing of the walking assistance device can be simplified. When wearing the walking assistance device, the user may first wear the hip belt without being hindered by the presence of the torque transmitting member. Thereafter, the torque transmitting member may be attached to the hip belt, and the lower end of the torque transmitting member may be fastened to the femur of the user.

### TECHNICAL FIELD

The present invention relates to a walking assistance device, and in particular to a walking assistance device that provides an assisting power to a person having a diminished muscle power for a lower limb.

### BACKGROUND OF THE INVENTION

There have been proposes various forms of walking assistance devices that assist movement of a lower limb of a person who has become unable to walk by himself or herself owing to a diminished muscle power that is typically caused by an injury, disease or aging, and such devices comprises a power generator worn on a body part adjacent to the hip joint of the wearer.

Such a device typically comprises a hip belt worn on a hip part of the wearer, a power generator mounted on the hip belt and provided with a torque output member, a torque transmitting member attached to the torque output member in a torque transmitting relationship and a lower limb member attached to the other end off the torque transmitting member and worn on the lower limb part of the wearer. See Japanese patent laid open publication No. 2006-320350 (patent document 1).

Japanese patent laid open publication No. 2004-344305 (patent document 2) discloses a device that incorporates a power generator and a torque transmitting member as an integrated drive unit in such a manner that the drive unit may be detachably attached to a hip belt. In particular, the mounting and dismounting of the drive unit on and from the hip belt can be readily accomplished without requiring a too or the like by using a latch mechanism.

In the walking assistance device disclosed in patent document 1, because a torque transmitting member is attached to a power generator via threaded bolts, the attachment and removal of the torque transmitting member requires a tool, and this prevents easy and quick attachment and removal of the torque transmitting member. Therefore, this known walking assistance device has the following problems.

A user must wear a hip belt to which a torque transmitting member and a lower limb member are already attached, and these members dangling from the hip belt prevents easy and quick wearing of the walking assistance device.

The walking assistance device permanently fitted with a torque transmitting member and a lower limb member is inconvenient for storage and transportation.

When a walking assistance device is shared by a number of people in a rehabilitation room of a medical institution, a large number of walking assistance devices of various sizes must be stocked or the component parts must be changed for each user so that the walking assistance device may fit the particular user. A significant initial cost is required in the former case, and a high running cost is required in the latter case.

In the case of the walking assistance device disclosed in patent document 2, a drive unit can be ready attached and detached to and from a hip belt by using a latch mechanism and without requiring any tool, the convenience of attachment/detachment, storage and transportation is improved. However, as the leg member is still an integral part of a power generator, there is some inconvenience when wearing the walking assistance device. Also, as the power generator is essentially permanently connected to the leg member, a large number of drive units must be stocked in order to accommodate wearers of different and builds, and this requires an added cost.

### BRIEF SUMMARY OF THE INVENTION

In view of such problems of the prior art, a primary object of the present invention is to provide a walking assistance device that simplifies the attachment, detachment and replacement of a lower limb member.

A second object of the present invention is to provide a walking assistance device that can be readily adapted to different statures and builds of users, and thereby eliminate the need to stock a large number of devices of different sizes to cater for a large number of users.

A third object of the present invention is to provide a walking assistance device that can be readily separated into different parts so as to simplify repairing and servicing work.

According to the present invention, such objects can be at least partly accomplished by providing a walking assistance device, comprising: a hip belt configured to be worn on a waist or hip of a user; a power generator having a base member attached to a side of the hip belt and an output member having an engagement assembly; and a torque transmitting member having an upper end configured to be retained by the engagement assembly of the output member and a lower end configured to support a femur of the user; wherein the engagement assembly comprises a latch mechanism for detachably engaging the upper end of the torque transmitting member.

By thus allowing the torque transmitting member to be readily and easily attached and detached to and from the hip belt, wearing and removing of the walking assistance device can be simplified. When wearing the walking assistance device, the user may first wear the hip belt without being hindered by the presence of the torque transmitting member. Thereafter, the torque transmitting member may be attached to the hip belt, and the lower end of the torque transmitting member may be fastened to the femur of the user.

Also, by stocking a number of torque transmitting members of different sizes, the same power generator can be used by users of variously different statures and builds simply by selecting a torque transmitting member of an appropriate size.

According to a preferred embodiment of the present invention, the output member further comprises a slot opening at a lower side thereof for receiving the upper end of the torque transmitting member therein. In such a case, the latch mechanism may comprise a button member supported by the output member so as to be moveable between a retracted position staying clear from the slot and a projected position projecting into the slot and a spring member urging the button member toward the projected position; and the upper end of the torque transmitting member may comprise an opening configured to be engaged by the button member at the projected position. Typically, the button member has an outer end configured to be depressed by the user.

To even further simplify the effort required to attach the torque transmitting member to the power generator, the button member comprises a sloping surface that causes the button member to be pushed toward the retracted position when the upper end of the torque transmitting member is pushed into the slot.

According to another preferred embodiment of the present invention, the power generator comprises an outer cover having a certain resiliency and a pressure member projecting from an inner wall surface of the outer cover, the pressure member being normally substantially out of contact from an outer end of the button member, but pressing the button member into the retracted position when the outer cover is depressed to a certain extent from an outer surface thereof, the pressure member comprising a sloping surface that allows the upper end of the torque transmitting member to be pushed into the slot and pulled out from a fully received position in the slot when the button member is pressed into the retracted position by the pressure member.

### BRIEF DESCRIPTION OF THE DRAWINGS

Now the present invention is described in the following with reference to the appended drawings, in which:

FIG. 1 is a simplified side view of a walking assistance device embodying the present invention;

FIGS. 2a is a side view of a power generator of the walking assistance device when a torque transmitting member is fully detached from the power generator;

FIG. 2b is a sectional view taken along line II-II of FIG. 2a;

FIG. 3a is a view similar to FIG. 2a when the torque transmitting member is being attached to the power generator;

FIG. 3b is a sectional view taken along line III-III of FIG. 3a;

FIG. 4a is a view similar to FIG. 2a when the torque transmitting member is fully attached to the power generator;

FIG. 5a is an enlarged front view of a button;

FIG. 5b is a sectional view taken along line V-V of FIG. 5a;

FIG. 6 is a sectional view of a second embodiment of the arrangement for detachably attaching the torque transmitting member to the power generator when the torque transmitting member is fully detached from the power generator;

FIG. 7 is a view similar to FIG. 6a when the torque transmitting member is being attached to the power generator; and

FIG. 8 is a view similar to FIG. 6a when the torque transmitting member is fully attached to the power generator.

### DETAILED DESCRIPTION OF THE PREFERRED EMBODIMENTS

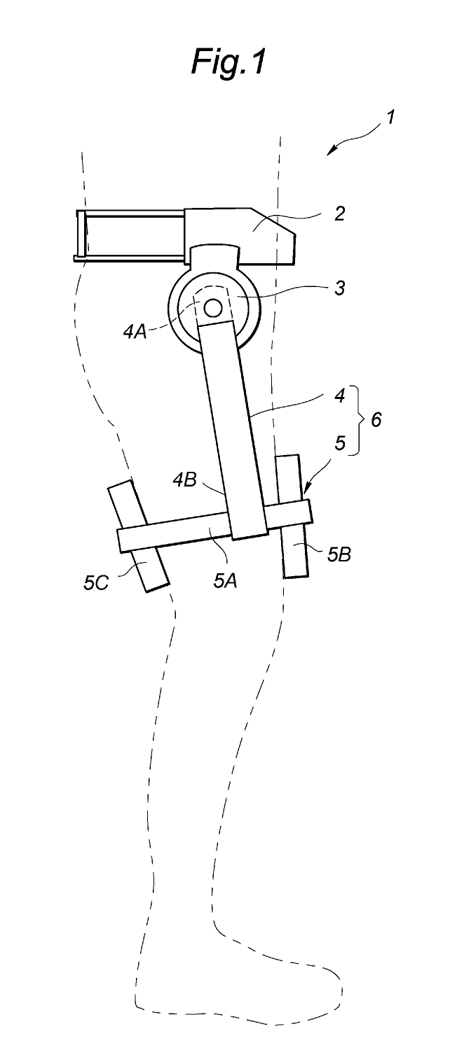

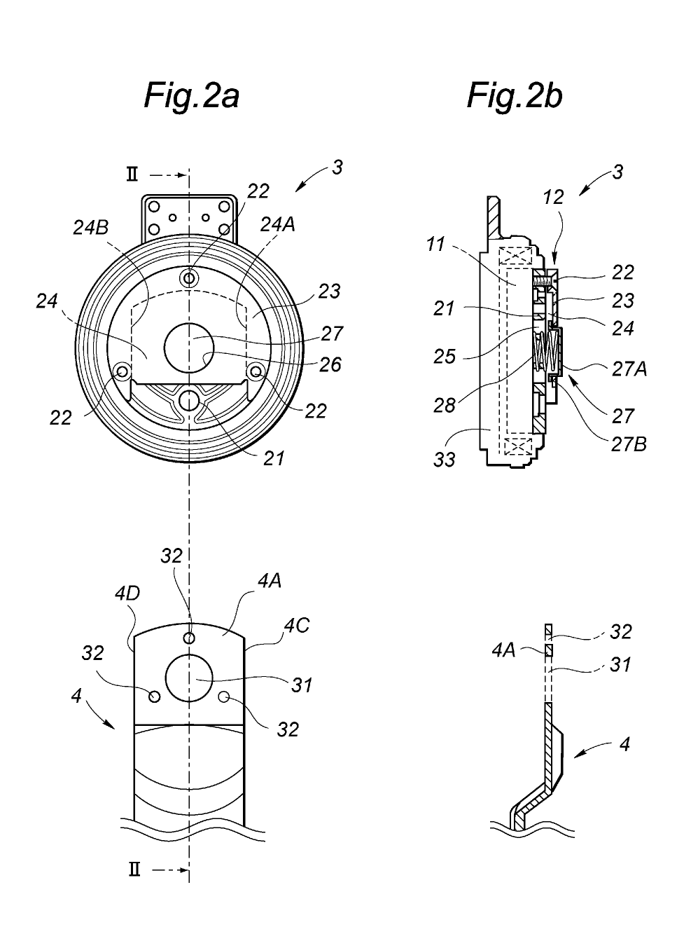

FIG. 1 is a side view of a walking assistance device embodying the present invention, and a profile of a user is indicated by dotted lines. FIGS. 2, 3 and 4 illustrate a power generator 3 and a torque transmitting member 4 when separated from each other, when being connected to each other, and when finally connected to each other, respectively.

The walking assistance device 1 comprises a hip belt 2, a pair of power generators 3 mounted on either side of the hip belt 2, a pair of torque transmitting members 4 extending from the respective power generators 3 and a pair of lower limb members 5 connected to the other ends of the respective torque transmitting members 4. The hip belt 2 is configured to be worn on the waist or hip of the wearer. The hip belt 2 is not limited by the illustrated embodiment, but may also be any member, soft or hard, that can be comfortably supported by the pelvis, waist, thigh or hip of the user. Each power generator 3 is configured to be attached to a corresponding side of the hip belt 2. Each torque transmitting member 4 includes a first end (upper end) 4A connected to a torque output assembly 12 of the corresponding power generator 3 in a torque transmitting relationship (FIG. 2b). Each lower limb member 5 is connected to a second end (lower end) 4B of the corresponding torque transmitting member 4. The hip belt 2 additionally supports a battery and a controller for the power generators 3.

Each lower limb member 5 includes a stem portion 5A made of a resilient material and having a shape of letter C as seen from above and a pair of pads 5B and 5C attached to either end of the stem portion 5A to hold a corresponding femur region of the user from front and rear, respectively. The second end 4B of the torque transmitting member 4 is fixedly connected to a middle part of the stem portion 5A. The first end of each torque transmitting member 4 is referred to as “connecting end” hereinafter, and an assembly of a torque transmitting member 4 and a lower limb member 5 is referred to as “lower limb assembly” 6 hereinafter.

When wearing the walking assistance device 1, first of all, the wearer wears the hip belt 2, and the power generators 3 which are attached to the hip belt 2 are placed on the corresponding hip joints of the wearer. The femur parts of the wearer are then each interposed between the corresponding pair of pads 5B and 5C. In the illustrated embodiment, the upper end of each power generator 3 is suspended from a side part of the hip belt 2 via a hinge that permits a swinging movement thereof around a hinge axis extending in the fore-and-aft direction of the wearer.

When the user moves the lower limbs forward and backward, this movement is detected by a sensor not shown in the drawings, and a rotor 11 of each power generator 3 is actuated according to the output signal of the sensor so that the output power of the power generator 3 is transmitted to the corresponding femur part of the wearer via the corresponding torque transmitting member 4 and lower limb member 5. The output of the power generators 3 is thus transmitted to the lower limbs of the wearer so as to assist the walking movement of the wearer.

Each torque transmitting member 4 may be made of metallic plate material having an elongated rectangular shape. In particular, the connecting end 4A of the torque transmitting member 4 is provided with linear side edges 4C and 4D extending in parallel to each other, and is centrally provided with a circular engagement opening 31. The free end of the connecting end 4A is rounded.

The connecting end 4A is provided with three mounting holes 32 arranged around the engagement opening 31 at a regular interval, and these mounting holes 32 may be used for attaching the torque transmitting member 4 by using threaded bolts to a power generator of a conventional arrangement. Therefore, the torque transmitting member 4 may be used interchangeably in both the illustrated embodiment according to the present invention and conventional arrangements.

Each power generator 3 comprises an electric motor that has a small axial dimension, and includes a base member 33 incorporated with a stator (not shown in the drawings) of the motor, a rotor 11 that cooperates with the stator of the motor and a disk-shaped torque output assembly 12 coaxially attached to the rotor 11 in a torque transmitting relationship. The torque output assembly 12 includes a drive plate 21 directly attached to the rotor 11 and a cover plate 23 attached to the drive plate 21 by using threaded bolts 22.

The cover plate 23 is provided with a recessed inner surface so as to define a receiving slot 24 in cooperation with the drive plate 21. The receiving slot 23 is provided with an open lower end and a pair of side walls 24A and 24B configured and dimensioned so as to receive the connecting end 4A of the corresponding torque transmitting member 4 in the receiving slot 24 from the open lower end thereof.

The drive plate 21 is centrally provided with a circular recess 25 so as to face the interior of the receiving slot 24, and the cover plate 23 is provided with a circular opening 26 passed across the thickness thereof in a coaxial relationship to the circular recess 25. The opening 26 is slightly smaller in diameter than the recess 25.

The recess 25 receives a hat shaped button 27 and a compression coil spring 28 interposed between the bottom of the recess 25 and button 27. The button 27 is provided with a cup shaped main body 27A having an open end facing the recess 25 and a flange 27B extending radially from the open end of the main body 27A. The main body 27A has a slightly smaller outer diameter than the diameter of the opening 26, and the compression coil spring 28 has a slightly smaller outer diameter than the inner diameter of the main body 27A. The flange 27B has an outer diameter which is larger than that of the opening 26 but smaller than that of the recess 25. As can be readily appreciated, the main body 27A and flange 27B of the button 27 are all arranged in a coaxial relationship to the recess 25 and opening 26.

Therefore, the main body 27A normally protrudes out of the opening 26 under the spring force of the compression coil spring 28, and the flange 27B is engaged by the peripheral inner wall surface of the cover plate 23. The recess 25 is given with a depth substantially equal to or greater than the total thickness of the button 27. Therefore, when the button 27 is depressed, for instance, by hand from the exterior, the button 27 may be completely received in the recess 25 against the spring force of the compression coil spring 28 which is entirely received within the main body 27A when the button 27 is fully depressed.

The engagement opening 31 of the connecting end 4A of the torque transmitting member 4 has a diameter slightly greater than the outer diameter of the button 27. Therefore, when the button 27 is fully depressed, the connecting end 4A of the torque transmitting member 4 may be inserted into the receiving slot 24 until the engagement opening 31 align with the main body 27A of the button 27. When the main body 27A of the button 27 is allowed to be received in the engagement opening 31 under the spring force of the compression coil spring 28, the torque transmitting member 4 becomes attached to the power generator 3. Because the side edges 4C and 4D of the connecting end 4A of the torque transmitting member 4 is engaged by the side walls 24A and 24B of the receiving slot 24, preferably without any play, the output torque of the power generator 3 can be transmitted to the torque transmitting member 4.

The torque transmitting relationship as used herein means that the associated two parts such as the toque output assembly 12 and output assembly of the power generator are joined integrally or rotational fast to each other.

The mode of operation of the illustrated embodiment is described in the following.

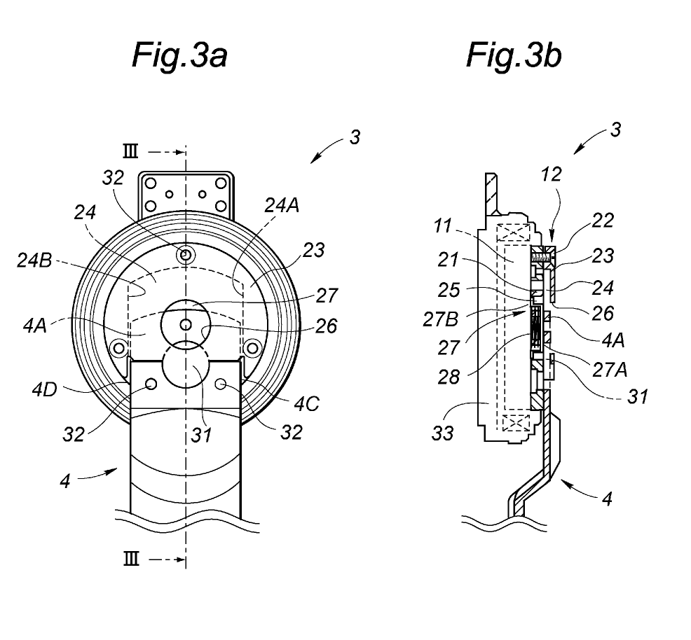

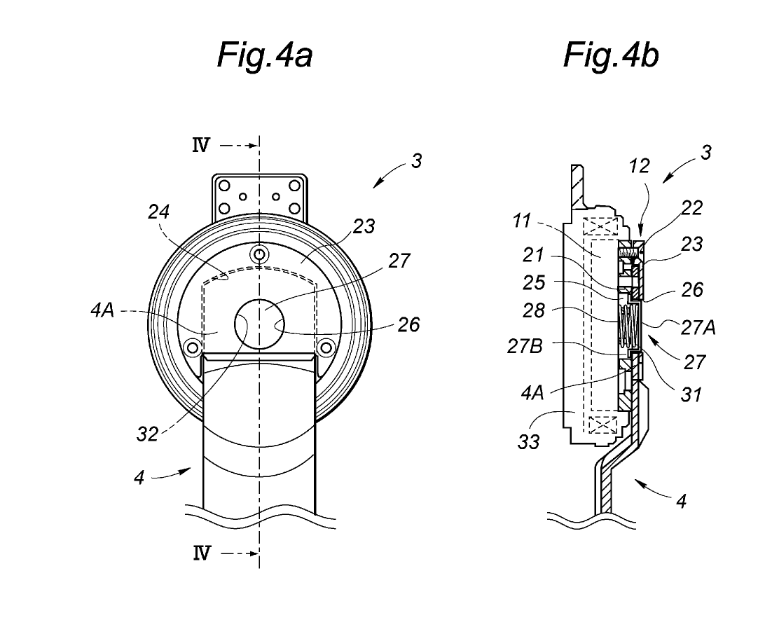

First of all, the button 27 of the power generator 2 is depressed by using a finger from the state illustrated in FIG. 2 until the button 27 is pushed into the recess 25 against the spring force of the compression coil spring 28. While the button 27 is thus depressed, the connecting end 4A of the torque transmitting member 4 is inserted into the receiving slot 24 as illustrated in FIG. 3. Once the connecting end 4A is pushed into the receiving slot 24 deep enough to keep the button 27 depressed, the button 27 is released. The connecting end 4A is then pushed further into the receiving slot 24 until the engagement opening 31 of the connecting end 4A has aligned with the button 27. This causes the main body 27A of the button 27 to be received in the engagement opening 31 of the connecting end 4A under the spring force of the compression coil spring 28 as illustrated in FIG. 4. Thus, the connecting end 4A is received in the receiving slot 24, and the flange 27B of the button 27 resiliently urges the connecting end 4A against the inner surface of the cover plate 23.

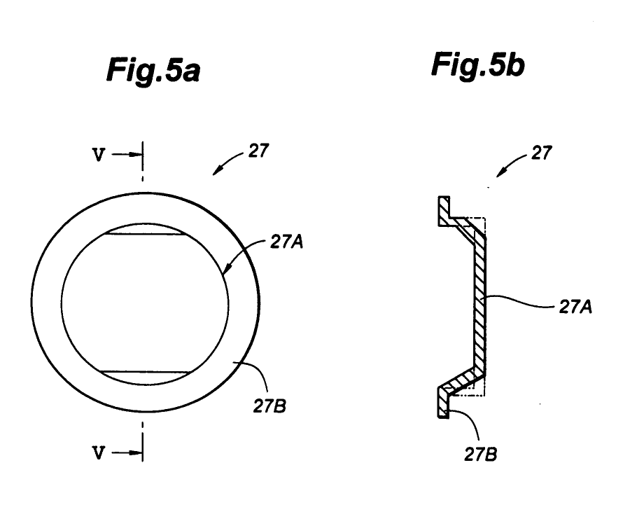

Thus, the connecting end 4A of the torque transmitting member 4 becomes attached to the output assembly 12 in a torque transmitting member. Optionally, the lower end of the main body 27A of the button 27 may be provided with a ramp as indicated in FIG. 5 so that the pushing the free end of the connecting end 4A into the receiving slot 24 causes the button 24 to be depressed into the recess 25. In such a case, there is no need to depress the button 27 with a finger or the like, and the torque transmitting member 4 may be engaged simply by pushing the connecting end into the receiving slot. This ramp or sloping surface may be planar, curved or otherwise profiled as long it enables the button 24 to be depressed when the free end of the connecting end 4A is pushed against it.

When the torque transmitting member 4 is desired to be removed from the power generator, the button 27 is depressed from the state illustrated in FIG. 4 against the spring force of the compression coil spring by using a finger or the like. Once the button 27 is received in the recess and clears the engagement opening of the connecting end, the torque transmitting member 4 is pulled out of the receiving slot 24. Thereby, the torque transmitting member 4 becomes detached from the power generator 3. Again, if a ramp is formed in the upper end of the main body of the button as indicated in FIG. 5, the detaching of the torque transmitting member 4 is facilitated. To avoid inadvertent detachment of the torque transmitting member 4, it is desirable that the upper end of the main body 27 of the button 27 is provided with an upright wall section of a certain height that continues to engage the engagement opening until the button is depressed to a certain extent as indicated in FIG. 5.

As can be appreciated from the foregoing description, the attachment and detachment of the torque transmitting member 4 from the power generator 3 can be accomplished readily and easily without requiring a tool. This facilitates the attaching and detaching of the torque transmitting member. Also, by stocking a large number of torque transmitting members of various sizes and a smaller number of power generators or hip belt assemblies each consisting of a hip belt and a pair of power generators, users of various statures and builds can be accommodated at a relatively small cost because the torque transmitting members are significantly less expensive than the hip belt assembly.

The various components associated with the mechanism for detachably retaining the power generator 3 may be selected without any restriction. In an actual example, the total weight of the various components was 56.2 g, and the breakdown of the contributions of weight of the various components is given in the following.

| components | material | weight (g) |
|---|---|---|
| drive plate | aluminum | 30.3 |
| cover plate | aluminum | 19.7 |
| button | aluminum | 1.9 |
| spring | steel | 1.3 |
| screws | steel | 3.0 |
| total | | 56.2 |

A corresponding mechanism without the detachable arrangement weighed 34.2 g, and the breakdown of the contributions of weight of the various components is given in the following.

| components | material | weight (g) |
|---|---|---|
| drive plate | aluminum | 27.8 |
| screws | steel | 6.4 |
| total | | 34.2 |

Thus, the increase in the weight was mere 22.0 g, and this means a minimal increase in the load on the user which is hardly noticeable.

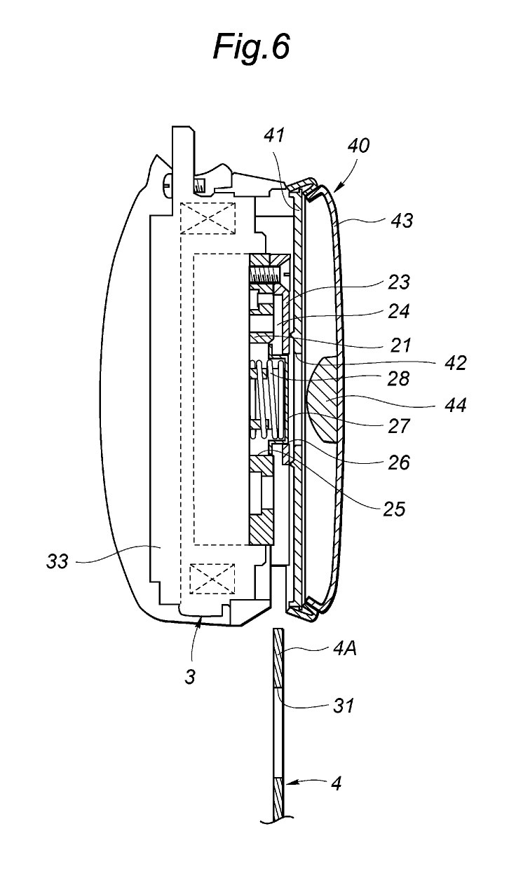

FIGS. 6 to 8 show a second embodiment of the present invention, and the parts corresponding to those of the first embodiment are denoted with like numerals without repeating the description of such parts.

Referring to FIG. 6, the power generator 3 of the second embodiment is provided with a cover assembly 40. (The first embodiment is also typically provided with a cover for concealing the inner mechanism of the power generator 3, but is omitted from illustration as it is not a part of the invention.) The cover assembly 40 includes a disk-shaped inner cover 41 attached to the base member 33 of the power generator 3 along an outer periphery thereof and provided with a central opening 42 substantially conformal to the opening 26 of the cover plate 23 and a dome shaped outer cover 43 which is disposed on the outer side of the inner cover 41 and also attached to the base member 33 of the power generator 3 along an outer periphery thereof. The dome shaped outer cover 43 may be made of resilient material, preferably plastic material having an attractive outer appearance. The outer cover 43 has a convex outer surface, and a concave inner surface. The concave inner wall surface of the outer cover 43 is centrally provided with a pressure member 44 projecting toward the button 27. The pressure member 44 is desirably provided with a smooth profile such as a semispherical shape, and has a free end which is in contact with or adjacent to the outer surface of the button 27, and does not depress the button 27 as illustrated in FIG. 6. In this condition, when the connecting end 4A of the torque transmitting member 4 is pushed into the slot, the connecting end 4A is pushed against the button 27, and is prevented from further insertion.

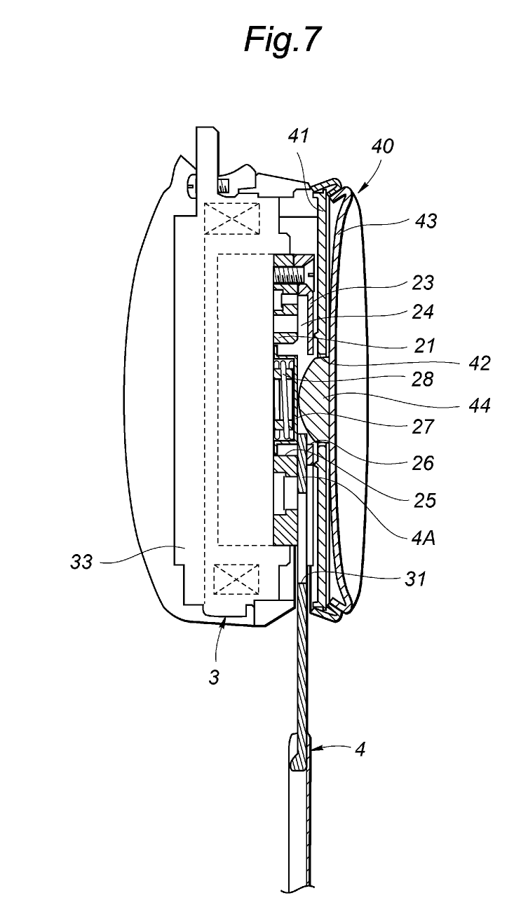

When the outer cover 43 is pressed from outside and pushes the pressure member 44 inward against the resilient force of the outer cover 43, the button 27 becomes depressed as illustrated in FIG. 7, and this allows the connecting end 4A to be inserted further inward because the button 27 goes out of way while the smooth contour of the pressure member 27 does not prevent the insertion of the connecting end 4A.

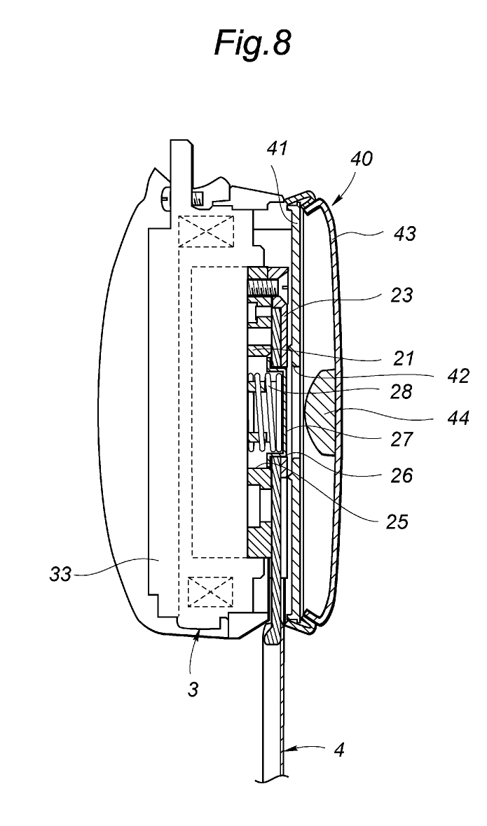

Once the connecting end 4A is fully inserted, the outer cover 43 is released from the external pressure. This causes the pressure member 44 to move away from the button 27 under the resilient force of the outer cover 43, and the button 27 to restore to the un-depressed state as illustrated in FIG. 8. As a result, the button 27 is received in the engagement opening 41 of the connecting end 4A, and this firmly secures the connecting end 4A to the power generator 3.

When the connecting end 4A is desired to be detached from the power generator 3, the outer cover 43 is pressed from outside. This causes the button 27 to be pushed out of the engagement opening 31 of the connecting end 4A, and the connecting end 4A to be allowed to be pulled out of the slot 24 without being hindered by the pressure member 44 owing to the smooth contour thereof.

The shape of the pressure member 44 is not limited by the above embodiment. For instance, the pressure member 44 may be provided with a frusto-conical shape, a frusto-semispherical shape or any other shape having a slanted or curved profile by which it could smoothly guide a corresponding part of the connecting end 4a.

Although the present invention has been described in terms of preferred embodiments thereof, it is obvious to a person skilled in the art that various alterations and modifications are possible without departing from the scope of the present invention which is set forth in the appended claims.

The contents of the original Japanese patent applications on which the Paris Convention priority claim is made for the present application are incorporated in this application by reference.

We claim:

1. A walking assistance device, comprising:
a hip belt configured to be worn on a waist or hip of a user;
a power generator having a base member attached to a side of the hip belt and an output member having an engagement assembly; and
a torque transmitting member having an upper end configured to be retained by the engagement assembly of the output member and a lower end configured to support a femur of the user;
wherein the engagement assembly comprises a latch mechanism for detachably engaging the upper end of the torque transmitting member.

2. The walking assistance device according to claim 1, wherein the output member further comprises a slot opening at a lower side thereof for receiving the upper end of the torque transmitting member therein.

3. The walking assistance device according to claim 2, wherein the latch mechanism comprises a button member supported by the output member so as to be moveable between a retracted position staying clear from the slot and a projected position projecting into the slot and a spring member urging the button member toward the projected position; and
the upper end of the torque transmitting member comprises an opening configured to be engaged by the button member at the projected position.

4. The walking assistance device according to claim 3, wherein the button member has an outer end configured to be depressed by the user.

5. The walking assistance device according to claim 3, wherein the button member comprises a sloping surface that causes the button member to be pushed toward the retracted position when the upper end of the torque transmitting member is pushed into the slot.

6. The walking assistance device according to claim 3, wherein the power generator comprises an outer cover having a certain resiliency and a pressure member projecting from an inner wall surface of the outer cover, the pressure member being normally substantially out of contact from an outer end of the button member, but pressing the button member into the retracted position when the outer cover is depressed to a certain extent from an outer surface thereof, the pressure member comprising a sloping surface that allows the upper end of the torque transmitting member to be pushed into the slot and pulled out from a fully received position in the slot when the button member is pressed into the retracted position by the pressure member.
